(19) United States
(12) Patent Application Publication
(10) Pub. No.: US 2004/0070931 A1
(43) Pub. Date: Apr. 15, 2004

(54) Type of modular keyboard for desktop computers

(76) Inventor: Lee Hong Wu, Lake Forest, CA (US)

Correspondence Address: LAW OFFICES OF J.F. LEE, 17800 CASTLETON STREET, SUITE 383, CITY OF INDUSTRY, CA, 91748, US

(21) Appl. No.: 10/272,584

(22) Filed: Oct. 15, 2002

(51) Int. Cl. G06F 1/16

(52) U.S. Cl. 361/686

(57) ABSTRACT

A new kind of module keyboard for desktop computers that separates keyboard components into two groups. One group of components becomes a detachable and user-serviceable module, while the other group stays as the base module. The detachable module contains essentially the keycap portion that contributes to more malfunctioning of present day keyboard. The base module contains the electrical circuitry membrane and PCB that has longer durability than the keycap portion. Depending on applications, the detachable module can be further broken into more sub-modules. Keyboards manufactured following present invention are modular in nature, and are conducive to reducing the costs for keyboard services and exchanges, costs for curing future environmental hazards and costs for fitting suitable user keycaps for swapping among different languages and computer applications.

### CROSS REFERENCE TO RELATED APPLICATION

The present application is related to a prior application filed by the same inventor. Said prior application's filing date was 06-26-2002, having application Ser. No. 10/180,423. Said prior application was an application of method claims upon the improved method of assembly for modular keyboards. Current application claims the disclosed structures of the modular keyboard for desktop computer.

### FIELD OF THE INVENTION

The present invention relates generally to keyboards for desktop computers where a top portion containing the keycap module, and other optional parts, is replaceable, removable and user-serviceable. More particularly, the present invention helps to solve the industry problems enumerated, but not limited by, below:

A. Voluminous amount of keyboards still under warranty are being returned for repair/exchange due to malfunctions that are user-serviceable. The amount of money that will be saved by avoiding such repair/exchange is estimated at least in the millions every year across the industry.

B. Substantially lesser amount of metal and rare metal contained in the bottom portion of a keyboard will not become scrap metal causing environmental hazards some years down the road because the bottom portion has long durability than the top portion. People are waking up to the potential hazards created by cast away computers, cell phones and other consumer electronics. Tremendous amount of money will be saved because of the reduced costs to cure the potential environmental hazards.

C. Cost of producing keyboards for different languages will be cut down to only a fraction thereof, because only a small portion of the keyboard needs to be replaced, not the whole keyboard.

D. Cost of tailoring keyboard for specific applications, as varied as computer gaming, hospital administration, diagnosis and sterilization afterwards, will be cut down to only a fraction thereof, because only a small portion of the keyboard needs to be replaced, not the whole keyboard.

### BACKGROUND OF THE INVENTION

Modern day keyboards for desktop computers come in an integrated package, along with the computer system units when sold. Users can plug in the keyboard cord to a port at the back of the system unit and can then start to type on the keyboard when the desktop computer is working.

Most desktop keyboards carry limited product warranty, on the condition that users do not take apart, disassemble or remove parts of keyboard in any way. Any such action voids the product warranty. If the keyboard develops any malfunction, the only recourse under the warranty is to have it returned for repair or exchange. Some manufacturers have sticker(s) covering one or more screws used to fasten the keyboard parts together. Any breaking or removal of such sticker(s) will also void the warranty.

In today's technology, most keyboards have fairly high quality and durability. However, in the real-life working environment, desktop keyboards are destined to encounter some foreign objects that tend to cause problems, including, just to name a few, grease from fingers, liquid spillage, dusts and particles in the atmosphere. Without any means to clear the accumulated foreign matter away, inevitably the mechanical functionality of the keyboard is adversely affected.

Typical symptoms include, keycaps stuck in the holding chimneys by the accumulation of dried coffee, grease or dusts. Due to the “void the warranty” restriction, the only solution is to return the keyboard for repair service or in exchange for a new one. Since the keyboard industry in general does not factor in the cost of recycling keyboard components, the cost of sending out a new keyboard to users is lower than the labor cost of diagnosing, fixing and re-assembling a returned keyboard. Hundreds of thousands of returned keyboards gravitated towards storage bins, warehouses and even garbage dumps each year, while no one bothers to figure out how to make the best use of the re-useable resources and come up with a more environmentally sound solution to the problem.

Such return for service/exchange, for fear of voiding the warranty, can be remedied by the new type of modular keyboard presented in present application. The modular keyboard envisioned by present application thus will help the keyboard industry save millions of dollars every year, and is more in tune with the worldwide trend of deployment of environmentally sustainable technology.

### DESCRIPTION OF THE PRIOR ART

The present invention examines the structure of a typical keyboard for modern day desktop computers, and proposes a new keyboard structure that helps to solve the industry problems.

Modern day keyboards for desktop computers are usually produced by using an upper and a lower enclosures (the outer shells for the finished keyboard product) to sandwich all internal components, which typically include keycap component, key-actuating mechanism, top holding plate, circuitry membrane and PCB, bottom holding plates/frame, and other optional components. Reference FIG. 1.

Since each manufacturer may have different assembly method, or may combine one part into another (bigger) part, understandably the components in FIG. 1 are just typical and not exhaustively representative.

From top to bottom (in the usual orientation of daily usage), these typical internal components (excluding the top/bottom enclosures) are listed and explained below:

1. keycap component: includes the following typical sub-components

a. individual keycap with alpha-numeric characters and other control keys for any specific language. The surface of each keycap, printed or labeled with character(s) for visual identification, is for human fingers to type on.

b. Keycap holding mechanism to provide for the vertical up-down travel of each keycap when pressed down and then popped back.

c. frame for the holding mechanism to sit on. In today's manufacturing process, the frame and the holding mechanism is usually an integrated structural piece.

2. top holding plate: optional, serves to hold down the key actuating mechanism and protect the components beneath.

3. key actuating mechanism: provides resistance and position restoration for each keycap. There are some variations as to the type of mechanism used for keyboard, to name a few:

a. Rubber dome (sheet): most common today, which uses dome-shaped material corresponding to each keycap.

b. Coil spring: vertical placement of coil springs along the up-down travel of each keycap, common for earlier generation keyboards; classical way of providing resistance and position restoration for each keycap.

c. Scissors switch: scissors-like cross levers with coil-springs or rubber domes to provide resistance and position restoration.

d. Flexible metal plate.

e. Buttons formed by sealed air bubbles on rubber or plastic material.

4. circuitry membrane and PCB: the combined circuitry membrane and PCB (printed circuitry board) electronically determine which of the keycap is being pressed down and send that information to the computer for further processing.

5. bottom holding plate: used to hold the previous components in place.

It is well known in the industry that these components are just typical, because a lot of variations exist due to different designs and manufacturing processes. For example, in earlier keyboard models, the coil springs (key actuating mechanism) are integrated with and became part of the keycap component.

FIG. 1 sums up the structural allocation of a typical keyboard for computers. As most people can experience and agree, these typical keyboards cannot be separated into two or more modules that can be physically removed, detached, replaced, swapped or serviced.

### OBJECTS AND SUMMARY OF THE INVENTION

Although there are some “modular” keyboards out on the market, they do not solve the problems enumerated herein. The salient deficiency of the traditional “modular” keyboard is the lack of the attribute wherein the portion of the keyboard component contributing to the malfunctioning is not isolated and encapsulated as a unit for user service. It is, therefore, present invention's objects to cure the deficiencies in the traditional (and the traditional type “modular”) keyboards.

One object of present invention seeks to greatly reduce the costs of diagnosing, fixing and reassembling a returned keyboard, or exchange for a new one, when warranty still applies.

A further object of present invention is to create a keyboard manufacturing technology that is environmentally friendly and is conducive to elimination of future environmental hazards.

A still further object of present invention is to allow and promote the use of swappable keycap modules to fit specific language used, typing pattern and different applications.

Present invention will allow the production of a new modular keyboard with removable, replaceable, swappable, interchangeable and user-serviceable keycap-modules.

### BRIEF DESCRIPTION OF THE DRAWINGS

The accompanying drawings, which are incorporated in and constitute a part of this specification, illustrate the preferred embodiment of the invention and together with the description, serve to explain the principles of the invention.

For reason of definition, and for further explanation of present invention, the term “top keycap-module”, aka “top module”, aka “removable module” will be used to denote the module that contains, minimally, the keycaps, key holding mechanism and frame for key holding mechanism. The term “bottom base-module”, aka “bottom module”, aka “base module” will denote the module that contains, minimally, the circuitry membrane and PCB. As a matter of practice, in a keyboard produced by present invention, anything other than the “removable module” is the “base module”.

A brief description of the drawings is as follows:

FIG. 1 shows the typical components of a keyboard for desktop computers.

FIG. 2a shows a first embodiment of present invention, where keycaps, keycap holding mechanism, frame for the holding mechanism and an optional upper enclosure are group into a “top keycap-module”, the rest of the keyboard components are grouped to a “bottom module.”

FIG. 2b shows an alternative embodiment of present invention as described in FIG. 2a, wherein said upper enclosure is grouped to the “bottom module.”

FIG. 3a shows another embodiment of present invention, where keycaps, keycap holding mechanism, frame for the holding mechanism, key actuating mechanism and an optional top holding plate are group into a “top keycap-module”, the rest of the keyboard components are grouped to a “bottom module.”

FIG. 3b shows an alternative embodiment of present invention as described in FIG. 3a, wherein the upper enclosure is grouped to the “bottom module.”

As can be imagined, many more embodiments can be made that cannot be exhaustively enumerated. The present invention, however, treats any top keycap-module as having the three basic elements of keycaps, keycap holding mechanism and frame for keycap holding mechanism. The present invention treats any base module as having the circuitry membrane/PCB element and any components of a keyboard that is not part of the top keycap-module.

FIG. 4 shows the top keycap-module in one piece, without outer enclosure.

FIG. 5 shows the top keycap-module can be sub-divided into more pieces, in this case, 3 pieces.

FIG. 6 shows the top keycap-module in 6 pieces.

FIG. 7 shows the top keycap-module can be sub-divided right down the main typing area.

FIG. 8 shows the top keycap-module can include an outer (upper) enclosure.

FIG. 9 shows the top keycap-modules as implemented on an ergonomic type keyboard.

FIG. 10 shows the top keycap-modules as implemented on a foldable plate.

FIG. 11 shows the top keycap-modules can be implemented to fit different types of keycap designation, such as QWERTY type or the DVORAK type. Keycap characters of different languages and applications can also be more economically implemented by using current invention.

FIG. 12 through FIG. 18 show examples of means of mounting top keycap-module(s) to the bottom base-module.

FIG. 12 shows the top keycap-module can be mounted and secured to the bottom base-module assembly by screws in the top-down orientation.

FIG. 13 shows the top keycap-module can be mounted and secured to the bottom base-module assembly by screws in the bottom-up orientation.

FIG. 14 shows the top keycap-module can be mounted and secured to the bottom base-module by snap-in tabs on the sides of the top keycap-module to the grooves located on the sides of the bottom base-module.

FIG. 15 shows the top keycap-module can be mounted and secured to the bottom base-module by yet another form of snap-in mechanism. In this drawing, upper enclosure is part of the top keycap-module.

FIG. 16 shows the top keycap-module can be mounted and secured to the bottom base-module by employing a latch-hinge mechanism.

FIG. 17 shows the top keycap-module can be mounted and secured to the bottom base-module by employing tabs with holes extending from the sides of top keycap-module, and corresponding cavities on the sides of the bottom base-module with sliding locking pins to engage or disengage the tabs. The allocation of tabs/cavities can be reversed, that is, the tabs can be on the sides of the bottom base-module, while the sliding locking pins are on the sides of the top keycap-module.

FIG. 18 shows the top keycap-module can be mounted and secured to the bottom base-module assembly by horizontally sliding the top keycap-module into the bottom base-module. A number of tabs and hooks are used to engage and disengaged the top keycap-module.

### DETAILED DESCRIPTION OF THE PREFERRED EMBODIMENT

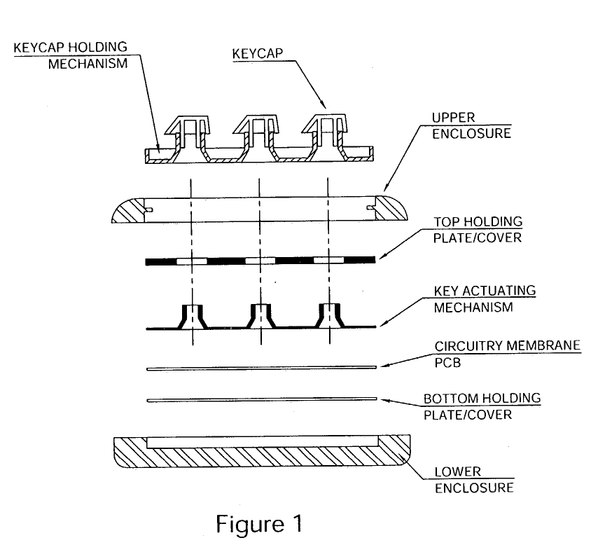

In FIG. 1, the typical components of a keyboard are shown. Terms “top keycap-module” and “bottom base-module” are used here and explained below.

Top keycap-module are made up of (1) the individual keycaps, (2) holding mechanism to provide the vertical up-down travel of the keycaps, and (3) frame for the holding mechanism.

Bottom base-module corresponds to the remaining components of a keyboard unit not belonging to the top module assembly. As a matter of practice, the bottom base-module will at least have the electrical circuitry/PCB component. From top to bottom, the components will include top holding plate, key-actuating mechanism, electrical circuitry membrane/PCB, and bottom holding plate.

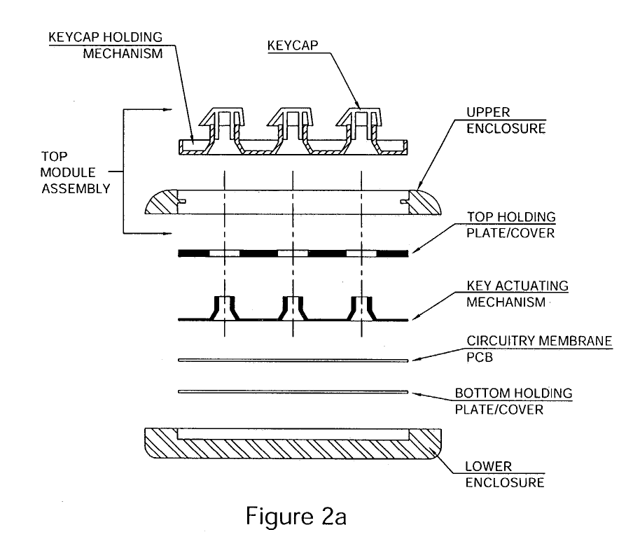

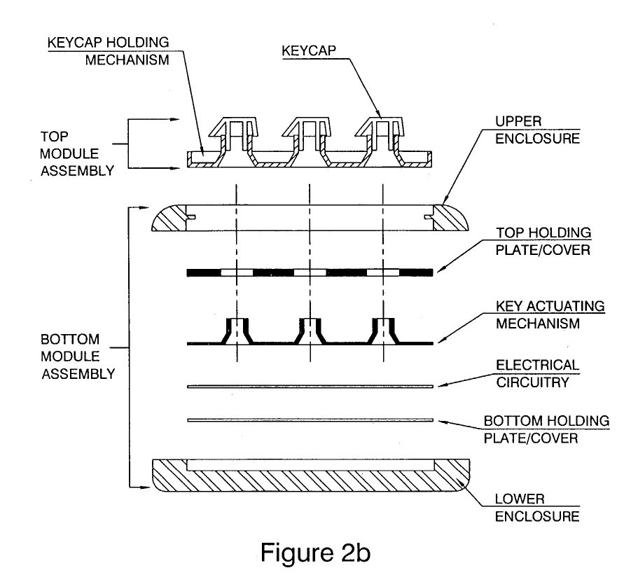

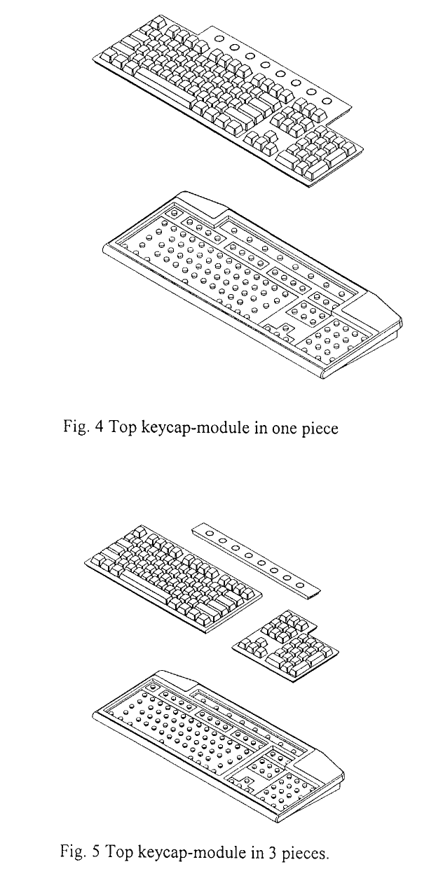

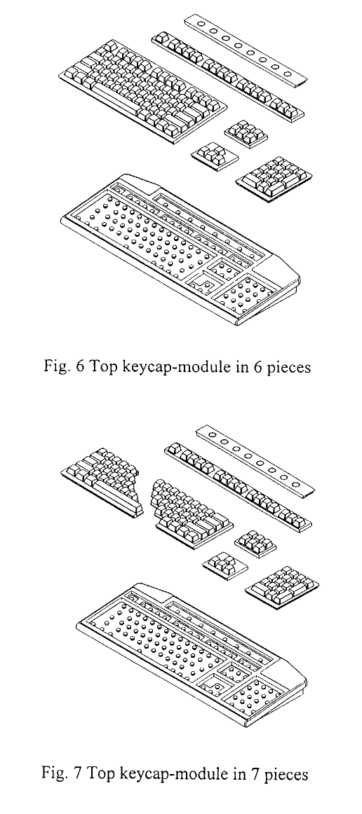

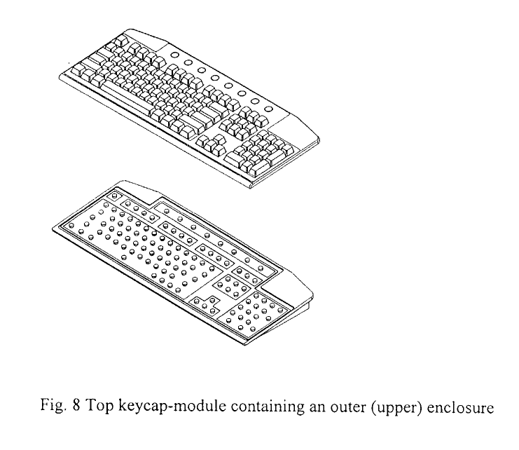

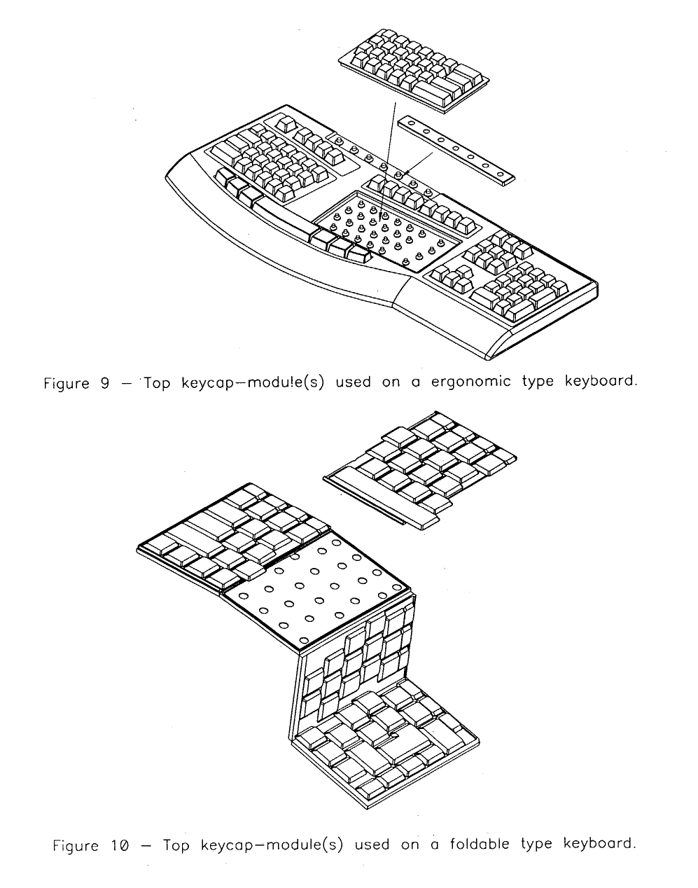

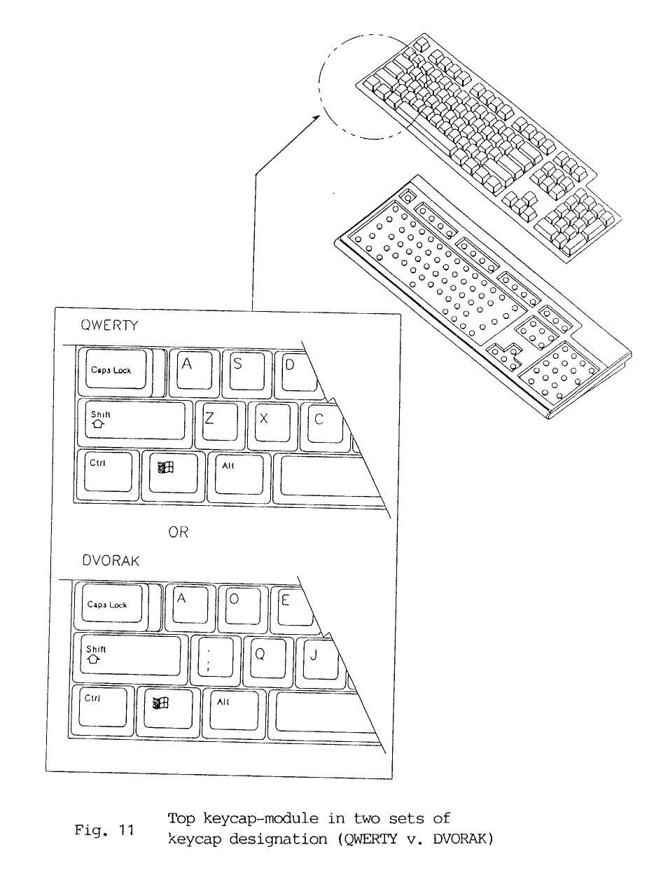

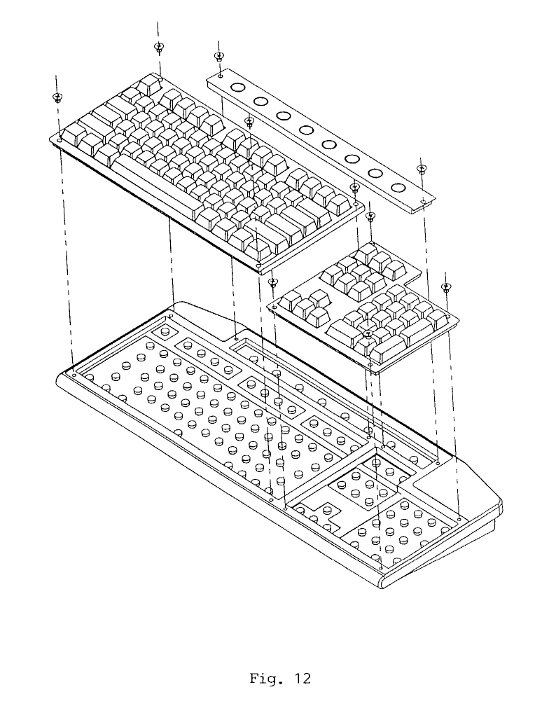

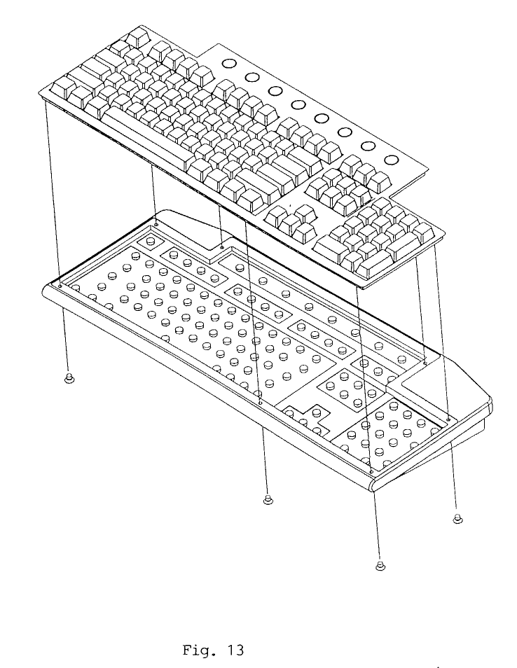

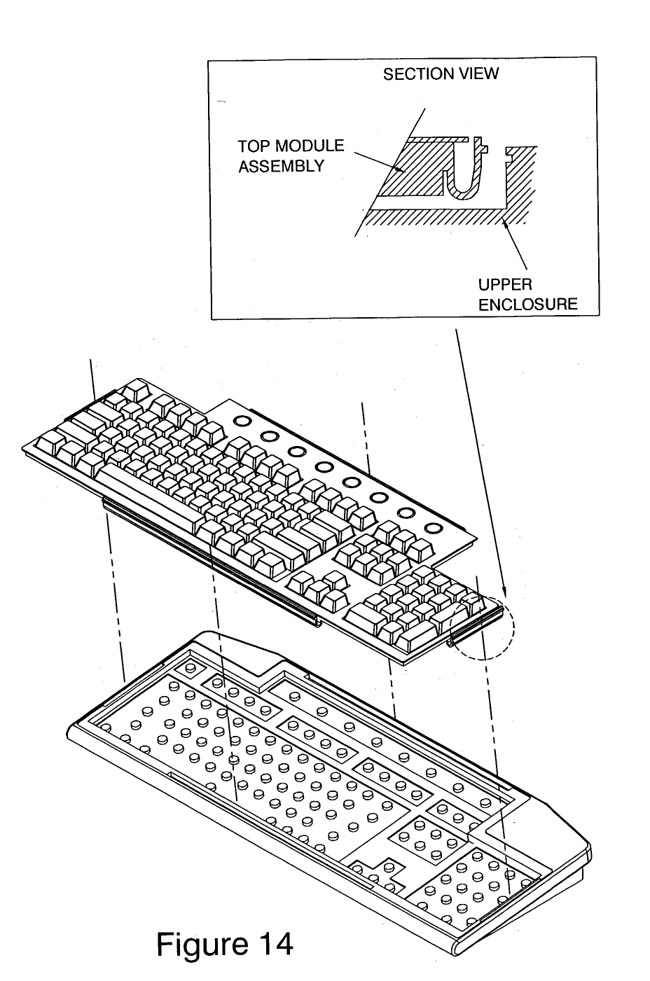

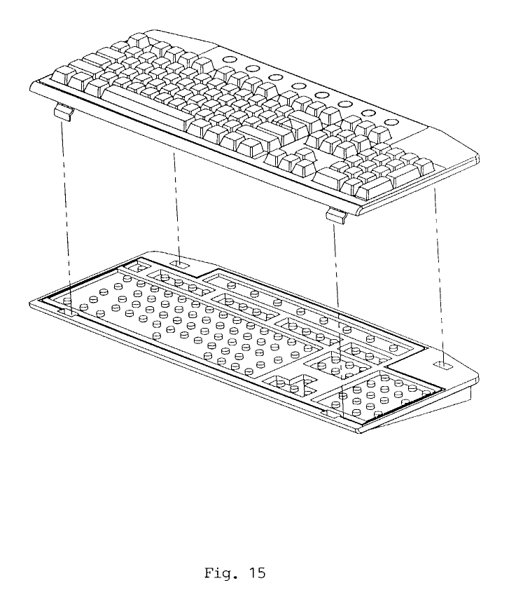

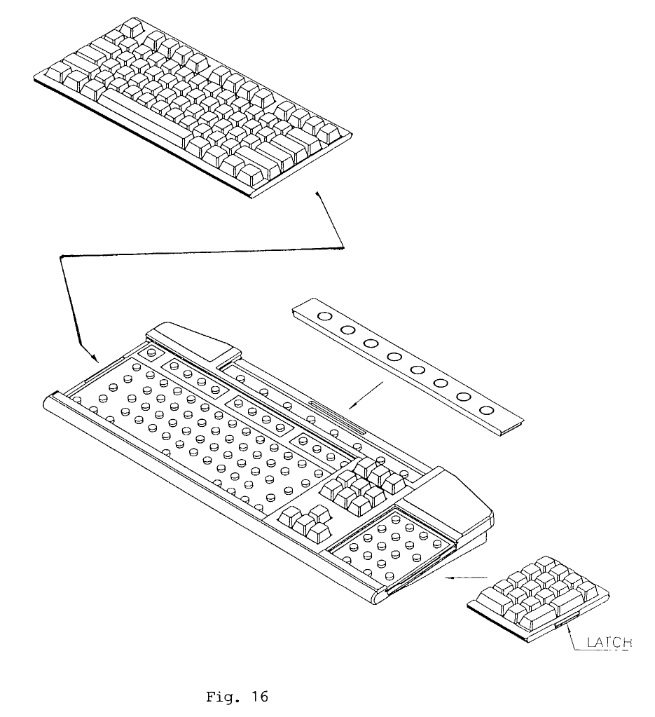

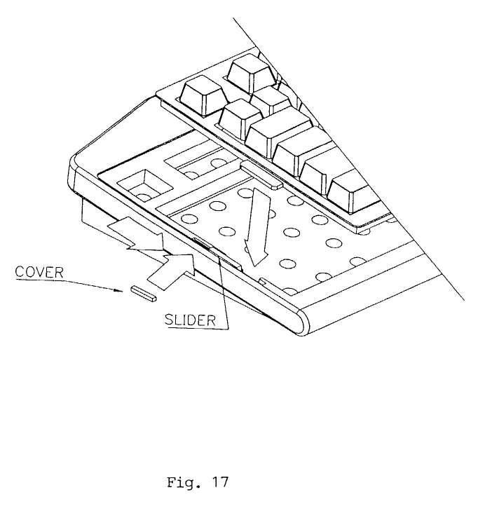

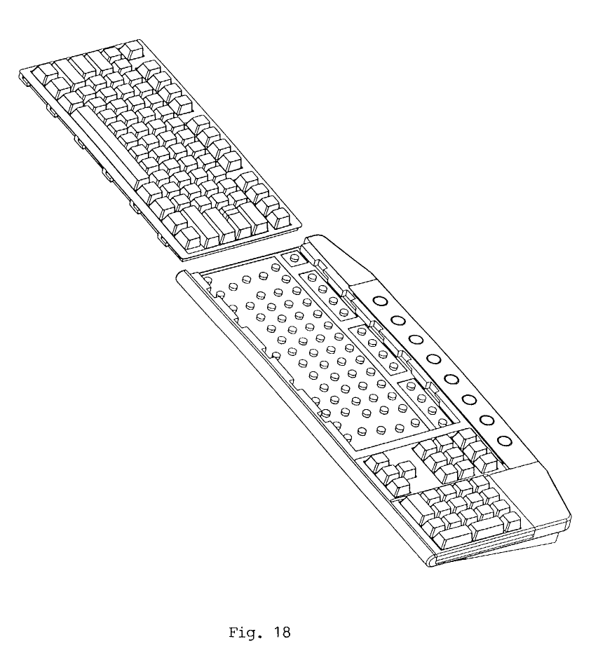

In one embodiment, present invention groups the upper enclosure (the hard plastic casing of a keyboard) into the top keycap-module, as shown in FIG. 2a and FIG. 8. In an alternative embodiment, upper enclosure can be grouped into bottom base-module, as shown in FIG. 2b and FIG. 4.

Because the top keycap-module contains the parts that are causing the malfunctions and the consequential return for repair/exchange, a keyboard produced pursuant to present invention thus allows consumers to easily remove the top keycap-module and wash it in clean water or appropriate solution, or spray common lubricant (WD-40, for example) and fix the problems.

Different design and manufacturing process oftentimes combine 2 or 3 components and make them into one. Alternatively, one component may be bifurcated into 2 or 3 components. As long as the variation, combination or bifurcation creates functional equivalents, the structure of present invention applies to achieve the objects and goals stated earlier. For example, bottom holding plate could be part of the circuitry membrane/PCB component. Or, the upper and lower enclosures could be only one integrated piece, instead of two pieces to be joined together by some mechanical means.

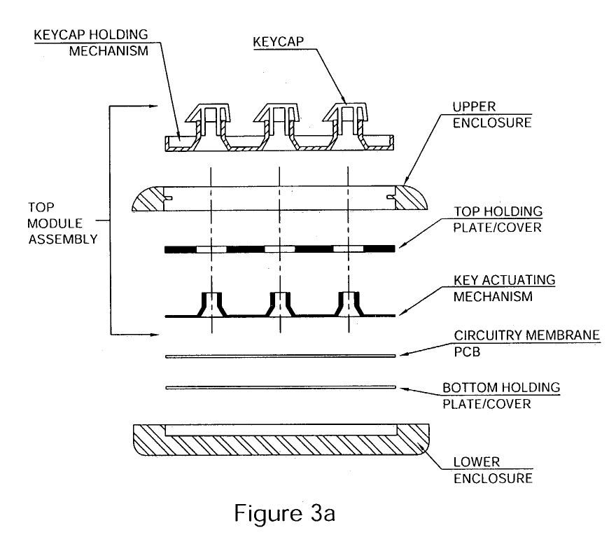

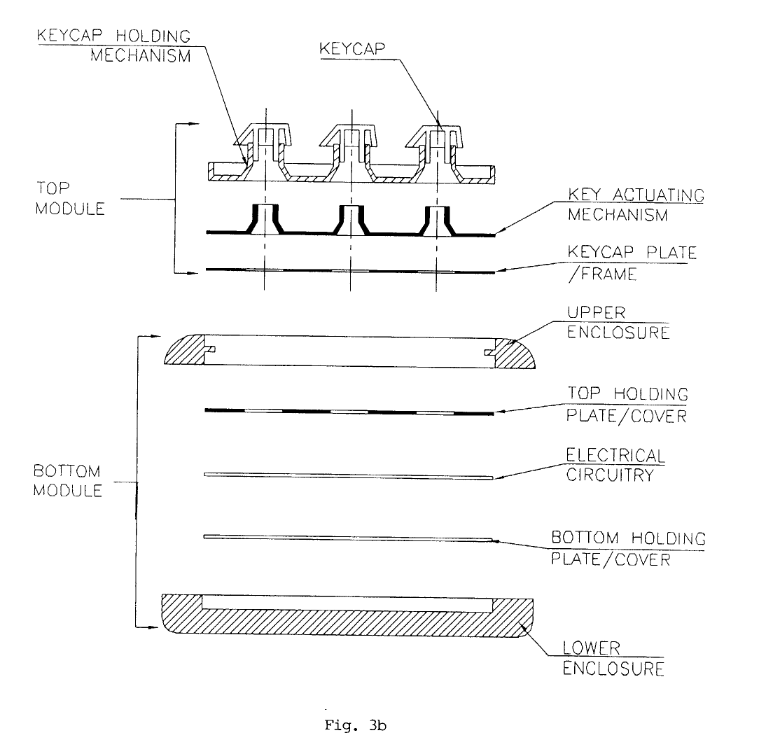

Depending on manufacture's design, alternatively, present invention envisions the possibility of including the upper enclosure into part of the top keycap-module, as shown by FIG. 2a, FIG. 3a and FIG. 8.

Present invention envisions the variation of grouping the key-actuating mechanism into either the top keycap-module or the bottom base-module, as shown by FIGS. 2a, 2b v.s. and FIGS. 3a, 3b.

What is claimed is:

1. A new type of modular and detachable computer keyboard, comprising:
a. A top keycap-module having keycaps, keycap holding mechanism, frame for said keycap holding mechanism;
b. A bottom base-module having electrical circuitry/PCB;
c. A key actuating mechanism that can either be place into said top keycap-module or said bottom base-module;
d. Means for mounting said top module to bottom module so that said top module can be easily removed from the keyboard while leaving the bottom module intact.

2. The computer keyboard of claim 1, wherein said top keycap-module and said bottom base-module have optional holding plates to hold together, and/or protect, the components within said top and bottom modules.

3. The computer keyboard of claim 1, wherein said top keycap-module and said bottom base-module may have optional outer enclosures.

4. The computer keyboard of claim 1, wherein said top keycap-module can be subdivided into two, three or more sub-keycap-modules.

5. The computer keyboard of claim 2, 3, 4, wherein the said means for mounting said top key-cap module to said bottom base-module is by one or a plurality of screws in the top-down orientation, so that a user can remove the top module by removing the screws and unseat the top keycap-module away from the bottom module.

6. The computer keyboard of claim 2, 3, 4, wherein the said means for mounting said top keycap-module to said bottom base-module is by one or a plurality of screws in the bottom-up orientation, so that a user can remove the top keycap-module by removing the screws and unseat the top keycap-module away from the bottom base-module.

7. The computer keyboard of claim 2, 3, 4, wherein the said means for mounting said top keycap-module to said bottom base-module is by one or a plurality of snap-in tabs, so that a user can remove the top keycap-module by depressing said snap-in tabs from its engaged cavity and unseat the top keycap-module away from the bottom base-module.

8. The computer keyboard of claim 2, 3, 4, wherein the said means for mounting said top keycap-module to said bottom base-module is by one or a plurality of latch-hinge mechanisms, so that a user can remove the top keycap-module by unlatching and unhinging the top keycap-module and unseat the top keycap-module away from the bottom base-module.

9. The computer keyboard of claim 2, 3, 4, wherein the said means for mounting said top keycap-module to said bottom base-module is by one or a plurality of slidable locking pins on said base-module corresponding to one or a plurality of tabs with holes on said keycap-module, so that a user can remove the top keycap-module by sliding the pins to disengage the slide-lock and unseat the top keycap-module away from the bottom base-module.

10. The computer keyboard of claim 2, 3, 4, wherein the said means for mounting said top keycap-module to said bottom base-module is by one or a plurality of tab-like hooks on said keycap-module, so that a user can remove the top keycap-module by slightly prying away the hooks and unseat the top keycap-module away from the bottom base-module.
